(19) United States
(12) Patent Application Publication
(10) Pub. No.: US 2013/0080289 A1
(43) Pub. Date: Mar. 28, 2013

(54) RETAIL SHOPPING

(71) Applicants: Rupessh Ranen Roy, Santa Clara, CA (US); Shyam Sundar Challa, Santa Clara, CA (US)

(72) Inventors: Rupessh Ranen Roy, Santa Clara, CA (US); Shyam Sundar Challa, Santa Clara, CA (US)

(21) Appl. No.: 13/628,035

(22) Filed: Sep. 26, 2012

Related U.S. Application Data
(60) Provisional application No. 61/540,112, filed on Sep. 28, 2011.

(51) Int. Cl. G06Q 30/00

(52) U.S. Cl. 705/26.8

(57) ABSTRACT

Apparatus and methods of improving retail shopping are described. In some examples, product-identifying information associated with a user identifier is received from a remote network node. Respective product identifiers are determined based on the received product identifying information. A personal shopping database of shopping records respectively including the determined product identifiers is maintained in association with the user identifier. Information relating to one or more of the shopping records in the personal shopping database is ascertained. The ascertained information is transmitted to the remote network device. In addition, handheld devices, demagnetizing stations, and labels for improving retail shopping are described.

### CROSS-REFERENCE TO RELATED APPLICATIONS

Under 35 U.S.C. §119(e), this application claims the benefit of U.S. Provisional Application No. 61/540,112, filed Sep. 28, 2011, the entirety of which is incorporated herein by reference.

### BACKGROUND

Retailing involves selling goods and services to customers. The success of a retail store depends on maintaining customer satisfaction. To this end, retailers strive to make a customer's shopping experience as efficient and effortless within the strict cost constraints inherent in competitive retailing environments.

### DESCRIPTION OF DRAWINGS

FIG. 1 is a diagrammatic view of an example of an automated retail shopping solution.

FIG. 2 is a diagrammatic view of an example of an automated retail shopping solution.

FIG. 3 is a diagrammatic view of an example of a graphical user interface.

FIG. 4 is a diagrammatic view of an example of a graphical user interface.

FIG. 5 is a diagrammatic view of an example of a graphical user interface.

FIG. 6 is a diagrammatic view of an example of a network that includes a demagnetizing station.

FIG. 7 is a diagrammatic view of a demagnetizing station.

FIG. 8 is a diagrammatic view of an example of a magnetic dot carrying label.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### 1. Definition of Terms

A “computer” is any machine, device, or apparatus that processes data according to computer-readable instructions that are stored on a computer-readable medium either temporarily or permanently. A “computer operating system” is a software component of a computer system that manages and coordinates the performance of tasks and the sharing of computing and hardware resources. A “software application” (also referred to as software, an application, computer software, a computer application, a program, and a computer program) is a set of instructions that a computer can interpret and execute to perform one or more specific tasks. A “data file” is a block of information that durably stores data for use by a software application.

The term “computer-readable medium” refers to any tangible, non-transitory medium capable storing information (e.g., instructions and data) that is readable by a machine (e.g., a computer). Storage devices suitable for tangibly embodying such information include, but are not limited to, all forms of physical, non-transitory computer-readable memory, including, for example, semiconductor memory devices, such as random access memory (RAM), EPROM, EEPROM, and Flash memory devices, magnetic disks such as internal hard disks and removable hard disks, magneto-optical disks, DVD-ROM/RAM, and CD-ROM/RAM.

### 2. Overview

The examples that are described herein enable a customer to maintain shopping history and current shopping list and do a real-time search to locate the nearest store that would provide the lowest total cost. Once the store is located the customer is shown directions to the store. This solution also has the capability to guide a customer within the store and locate the items. The customer also has the option to transmit the order online and have the shopping bag ready for pick-up at a drive through section of the store. The customer can create shopping lists by selecting from frequently shopped for items or by scanning the bar code of items. The software can also accept normal voice commands and interpret them. The solution also helps the retailer/manufacturer promote relevant products based on the consumers' shopping history, habits and current shopping list. For in-store shopping the customer walks into a retail store with a Smart Mobile Device and picks up an item/s, scans the bar code, pays using any preferred online method and then has a receipt generated for the purchase along with a QR code and then if needed print the receipt. The customer flashes the receipt to the checker at the door and exits. This would make the shopping experience quick, efficient and cost effective for the customer and enables the retailers to attract customers to their store, cross-sell and promote new products thus increasing overall revenue. The automated payment and check-out system eliminates store check-out counter and saves floor space and thus increases revenue per square foot and profits. Big Data from the solution enables optimal supply chain design and targeted marketing and promotions.

The major components of the solution include:
A Smart Device that can be, for example, an iPhone, iPad, Tablet, iPod, Android phone, Windows based phone or the like with a 3G/4G or higher data connection and/or Wi-Fi connection. These devices usually have a built in camera, microphone, speaker and GPS capability.
A Social Mobile Location (SoMoLo) application running on the phone which has an easy to use user interface and communicates through the phone data connection, Wi-Fi or similar data connection with the database of the retail store.
A payment gateway like Google Wallet, PayPal, VISA, MASTERCARD, American Express, Mobibucks, Square, or similar.
A demagnetizing station to demagnetize items that have a security device.
A Barcode or Quick Response (QR) code scanner to scan the barcode generated on the phone after the sale is complete or;
A printer to print the receipt. The printer can communicate with the Smart Device via Bluetooth or Near Field Communication or be connected to the barcode/QR code scanner. or;
A display screen connected to a barcode/QR code scanner or;
A manual keypad to enter the unique transaction number that is generated after payment is complete. This keypad is connected to a printer which then prints out a receipt.
A manual checker at the exit to verify that the items on the receipt match the total number of items in the basket or
A magnetic counter to count the number of items and match against the number of items paid for during exit
A Social Mobile Location (SoMoLo) based Software application running on the mobile device.
A Multi-Data Management System (MDMS) backend server communicating with the store database and inventory system.

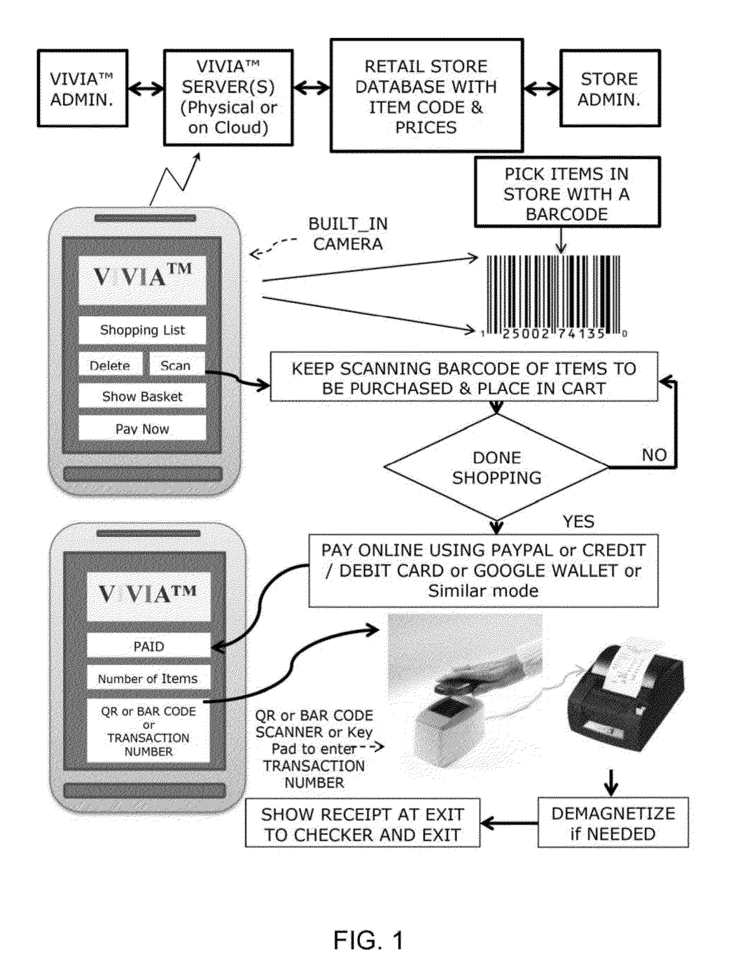

FIG. 1 shows a block diagram of an example of an automated retail shopping solution with printed receipt before checkout. With the VIVIA™ solution a consumer can typically shop using any device connected to the network like a personal computer, laptop, iPad or smart mobile device. FIG. 1 depicts a smart mobile device which can be used for in-store shopping. The smart mobile is equipped with a camera, touch-screen or keypad, and wireless data connection e.g. 3G/4G or WiFi or Bluetooth. The consumer uses the camera in the smart mobile device to scan the bar code or similar of the product and then places them in his shopping cart. In some variations RFID or near field communication (NFC) may be used to scan the product. As an alternative to placing the item in the shopping cart the product codes may be transmitted to the pick-up counter where all the items are kept ready in a shopping bag for pick-up. The solution includes one or more VIVIA™ servers that communicate with a database that is maintained by the retail store. The VIVIA™ server may be a physical box or in the cloud. The App running on the smart mobile device communicates with the VIVIA™ server over the wireless connection. Information such as the scanned product codes are transmitted to the VIVIA™ server from the App and information such as product details, prices, location and coupon codes are received from the server by the App. The VIVIA™ server has an Admin panel that enables VIVIA™ to program user specific configuration in the Server based on the type of store, features to be provided etc. The Admin panel can also be used to manage user accounts, preferences and run statistics. The VIVIA™ server is Multi-Data Management System (MDMS) compatible which enables it to communicate with a wide variety of retailer database platforms e.g. Oracle and SAP. The retail store database stores information such as but not limited to the product codes, prices, location, quantity at hand and relevant coupons and promotions. The store database also has an Admin panel that can be accessed by the retailer and used to program product related information and run and view various statistics e.g. product demand which can help with the supply chain planning. When the consumer is done scanning all the products he wishes to purchase, the App generates a summary and indicates the total cost of the selected items. The customer then has the option to pay using any of the online payment methods e.g. Google Wallet, PayPal, VISA, MASTERCARD, American Express, Mobibucks, Square or similar. Payment is completed after suitable security verification and subsequently an online receipt for the sale and a unique transaction code are generated. At this point the customer walks up or is guided by the App to the nearest receipt printing station and does one of the following: a) places his smart device next to the sensor in case NFC technology is used or, b) Places the QR code generated on the screen in front of the optical sensor or, c) Keys in the unique transaction code in the keypad. The sensor or keypad communicates with the VIVIA™ server to ensure that the payment was received for the transaction and a receipt is printed for the consumer. At this point, if the consumer has the items in his shopping cart then he can then place items that need to be demagnetized on a demagnetizing pad which again communicates with the VIVIA™ server to ensure that payment has made and demagnetizes the sensor on the item and marks the item as sold thus reducing the inventory count for the item. The consumer finally shows the receipt to the checker at the exit who may match the items in the shopping cart to the total on the receipt and then the consumer departs. Alternatively, if the items are bagged and kept ready for pickup at the exit then the consumer walks up to the pick-up counter shows the receipt, collects his shopping bag and departs the store.

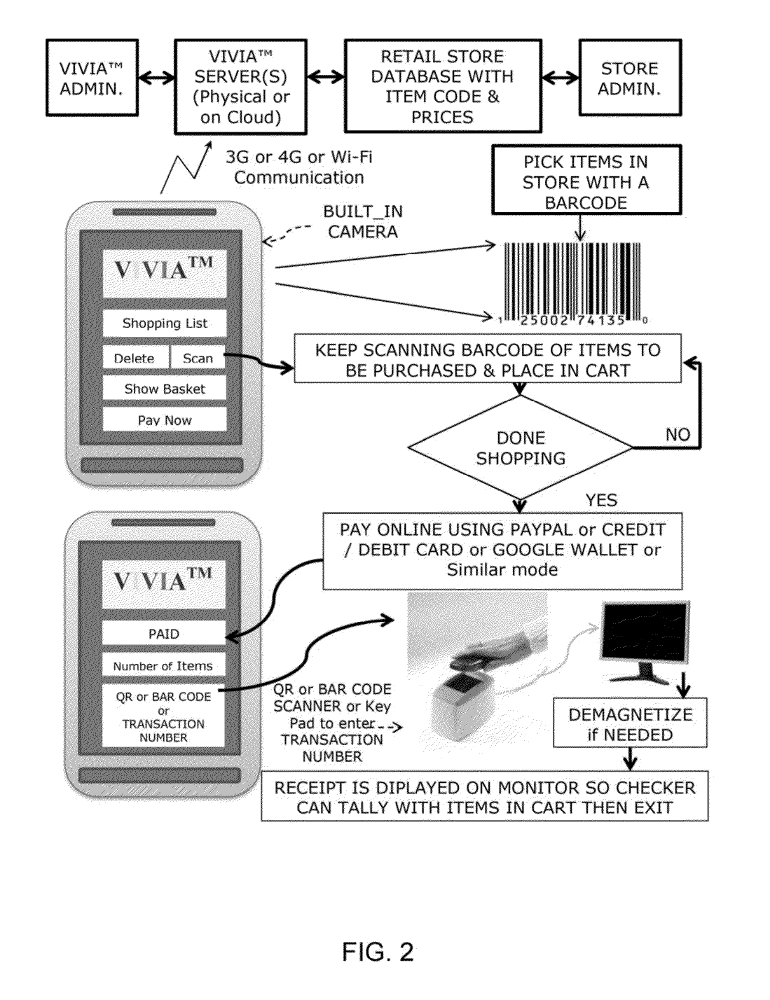

FIG. 2 shows a block diagram of an example of an automated retail shopping solution with receipt displayed on a screen at checkout. In FIG. 2, the receipt printing station is modified to be a receipt display station such that a checker at the exit just looks at the screen and confirms that the total number of items displayed on the receipt matches the total number of items in the shopping cart and then permits the customer to depart the store. The same is true if the customer walks up to a pick-up counter. The receipt is displayed on a screen when the customer does one of the following: a) places his smart device next to the sensor in case NFC technology is used; b) places the QR code generated on the screen in front of the optical sensor; or c) keys in the unique transaction code in the keypad. The customer can then collect his shopping bag and depart the store.

### 3. System Components

A. Smart Device

The Smart Device can be any brand of phone or other handheld device (e.g. Apple iPad or iPhone or iPod, Tablet, or mobile devices manufactured by companies like HTC, Motorola, Nokia, Samsung, LG, Google or the like) or model with any of the operating systems like Android, Windows, iOS, Symbian, or similar. The Smart Device typically has a built-in camera, GPS capability, Bluetooth and a wireless transceiver (e.g., a 3G or 4G mobile telecommunications transceiver or a Wi-Fi transceiver) for wirelessly communicating with other network nodes over a network.

B. The Application

Overview

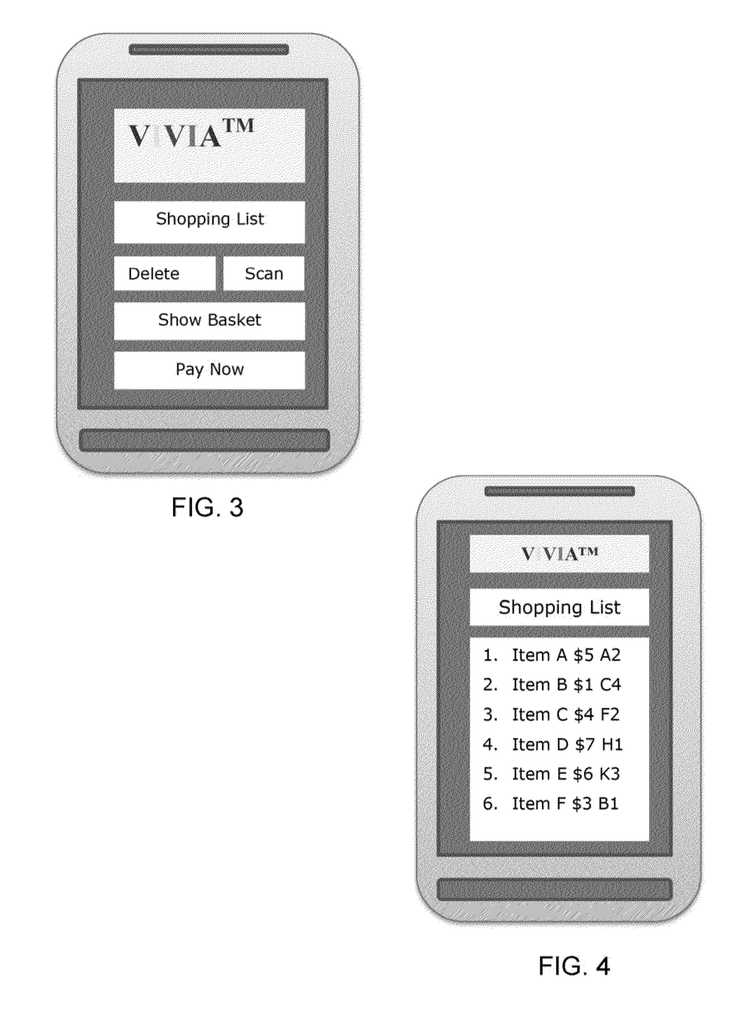

Referring to FIG. 3, the SoMoLo based software application (also referred to herein as the “app”) running on the Smart Device is compatible with the operating system platform of the phone. The basic functional blocks of the software application include all or some of the following blocks: a shopping list block that manages the creation, modification, and deletion of a list of shopping items on behalf of one or more users, each which is associated with a respective user ID; a voice recognition block that accepts voice commands that could range from naming a product to sentences like “help me find the nearest store that offers the best price on a Canon XYZ camera” or “transmit this shopping list to ABC store and have them keep my shopping bag ready for pickup at 5 pm”; a network interface block that manages interactions with one or more VIVIA™ servers; a search engine that does a live search of the prices of various products in the shopping list and compares the prices/deals being offered by the stores within a chosen search radius and returns the best total price for the current shopping list; a social network that enables users to share deals with others using one-click; an engine that enables retailers promote products and deals based on a customers' shopping history, behavior and current list; a scanner block that interfaces with the camera of the Smart Device for scanning items (e.g., barcode labels on the items); a GPS block that interfaces with the GPS sensors in the smart device to enable store location detection and location within the store; a Bluetooth and or Wi-Fi interface block to communicate with sensors within the store to help locate aisles, demagnetizing stations, printers, exits etc.; a payment processing block that communicates with the payment gateway to process the payment and generate the receipt and unique transaction code; and a graphical user interface block that manages the graphical user interface that is presented to the user. The one or more VIVIA™ Servers manage one or more Databases that store various retail-shopping related information, including records of purchases made by the user. The VIVIA™ servers support queries on the Databases by the app running on the Smart mobile device as necessary.

In some examples, the VIVIA™ Server(s) can take the pricing and item codes from the retail store database and combine these codes with the shopping list information for a customer, his shopping history, and the discounts database to generate special prices and deal codes. It can also send targeted emails or place ads in the existing shopping lists to promote similar products from other manufacturers or new products. The VIVIA™ service environment includes the following service components:

The Login Module

This module checks the login id and password entered by a customer against the encrypted information stored in the VIVIA™ server. Only when there is a match is a customer allowed to move forward.

The Shopping Database

This module stores the historical shopping information for a customer. A retailer can use this information to plan inventory.

The historical shopping information includes but is not limited to:
The dates, times, and locations of the customer's actual purchases;
Which items and brands do the customers shop for;
How many of these items do the customers shop for each time;
Which items are on the customers' upcoming shopping trip list;

Based on customers' frequency of store visits for a particular item and their next shopping lists, the retail stores can determine the anticipated number of products to be purchased in the next inventory cycle. This calculation can be aggregated over all customers using the VIVIA™ solution and integrated into the retail stores' inventory planning process. In this way, the VIVIA™ solution provides information regarding customer's actual planned purchases, enabling them to more accurately make inventory stocking decisions;

The Shopping Database supports a wide variety of different queries that can be used to provide value-added information to customers and retails stores. For example.
The dates, times, and locations of the customer's actual purchases can be used to determine the frequency with which customers shop for particular products, which is useful to retailers, e.g., in making inventory planning decisions.
The exact product, brand, size, feature and price for which shopped in the past. The customer can also query the “price trend” for a particular product;
Based on a customer's shopping behaviors, the data from this module can be used to recommend customers to make bulk purchases and save on their purchases.

The Frequent Shopper (Rewards Program) Module

This module queries the Shopping List database and the Discounts and Offers database to offer discounts and specials to a customer as he shops the store. Examples include:
If a customer regularly shops for Slim fit Jeans for example worth $100 and a new style is launched with a retail price of $200. The new style could be marketed to the customer along with a discount for $150. Since he is a loyal customer and likes the fit from the manufacturer he would be very likely to purchase it. This strategy could be applied to other items as well
If a customer shops for printer paper for example of a particular brand with a particular set of features. The database could search for printer paper from other manufacturers with similar or better features at a better price and prompt the customer to select one of the options.
If a customer regularly shops for juices for example at a particular price. The offers database could be scanned for organic juices with equal or slightly higher price and the customer could be prompted to considering purchasing the organic choice.

The prompting can be done in any of the following ways:
As a set of options updated to the shopping list
“Mini video clips” promoting the item and benefits
Link to Coupons
One line coupon
A pop-up ad

In the user preference setup the customer is able to choose how he would like the ads to be presented to him. For example, a customer has a particular Brand and style of jeans in his shopping list and there is a new style that a manufacturer is trying to promote. In this case, an icon would appear in the shopping list next to the item suggesting that there are options available and if the user clicks on this icon a mini video clip of the ad presenting the new jeans would be displayed to the customer. At the end of the ad the user is given the option to replace the item on the list with the presented option i.e. the new jean style. If the user clicks on this option then the old item is replaced with the new item and the customer is directed to the location of the new item. Another example could be a customer has a particular dress in her shopping list and the store inventory database has a coupon that could allow the customer to purchase a second dress for half off. Accordingly an icon would be placed next to the item in the shopping list. The customer would click on the icon to accept the offer and when she scans the second dress the discount would automatically be included.

The Discounts and Offers Database

This module contains a list of all the promotions being offered by the manufacturers and the store itself.

The discounts and offers can be obtained by any of the following methods:
The discounts are manually entered into the VIVIA™ Server through the Admin panel
The discounts are downloaded automatically from the Store database
Manufacturers and promoters would be assigned password protected accounts and can submit discounts and offers into the VIVIA™ server through a secure connection.

The Store Layout Database

This module contains the following key elements to enhance the customer shopping experience. The complete store layout including but not limited to the aisles and what each aisle and shelf contains. Thus all items in the store can be easily located by the aisle number and shelf in a format that looks somewhat like e.g. B23 where B is the aisle, 2 is the section in the aisle and 3 is the shelf. The retailers typically will enter this location information into their inventory database every time they add a new product to the database or if they plan to rearrange the location of items in the store. The database also contains the location of the key departments, services and conveniences in the store (e.g., the coffee shop, pharmacy department, restrooms, returns counter, exit counters, receipt printers and customer service desk to name a few of the many possibilities). After a customer has completed online payment the app would direct the customer to the nearest receipt printer and then to the nearest exit. Since the app knows the location of the customer within the store and the location of the receipt printer and exits (either using GPS technology or using positioning sensors installed within the store), it would provide step-by-step directions to reach these locations. All these are key components in speeding up the shopping time and enhancing the shopping experience.

The Store inventory Database

The store inventory database typically contains all the items currently in the store along with their prices and current quantity at hand among other things. Seasonal items that are not currently in inventory may or may not be downloaded into the VIVIA™ server depending on the requirements of the store i.e. whether they allow back-ordering of items. The item display locations are known by design and accordingly entered into the store inventory database when the item is first added to the database. Thus the Store Inventory Database and Store Layout Database are linked. The store admin would be able to query the database to figure out the inventory status at any point in time. Based on the shopping list database showing the potential sale (or demand) of items and the frequency of shopping of the corresponding customers the store could forecast the amount they would need to order and when.

In some examples, the app is customized for a store such that it has features that make shopping for the items convenient. The core engine of the App and the software running on the VIVIA™ Server would be the same. However, the GUI would be customized for a store to match its brand. For example the GUIs for Nordstrom, Toys-R-Us, Kroger, Office Depot, Wal-Mart, or Albertson's would each have a unique look and feel but most of the commonly used button names would be the same. Features and functionality unique to the store would be added as necessary. In some of these examples, the customization would include:
Store Name
Logo, personalization and unique branding of the store
Theme of the store based on the merchandise it carries
Location of the Store
Local prices in the store
In-store specials and deals of the day on excess inventory.
Store layout information to guide customers on location of items, departments (e.g. Pharmacy, Men's Shirts, Dairy, Kids shoes, customer service counter, returns counter—according to the type of store)
Rewards programs
Marketing strategies
Store Timings
Store contact numbers

The Voice Recognition Module

The VIVIA™ voice recognition module accepts voice commands in one or more languages as selected by the customer. A customer can speak control commands or data commands in simple language and the module converts them into commands and data recognized by the app. A consumer can say commands like:
Create a shopping list. Then name the products he would like to add to the list
Locate items that I shop for most often every week and create a shopping list for today. Then locate a store that offers the lowest total price and drive through pick-up
Help me find the nearest store that offers the best price on a Canon XYZ camera
Transmit this shopping list to ABC store and have them keep my shopping bag ready for pickup at 5 pm
Locate the nearest store that has the lowest total price for the items in my shopping cart
Show me similar products to XYZ
Show me reviews for products XYZ
Locate the nearest store that has the least waiting time for drive through pickup of my shopping bag

The Web Application

The VIVIA™ web application allows customers to access all their information from any computer or smart device with internet access. This makes it easy for customers to print out their receipts at home or print a report of their monthly activity for personal or business accounting or any other reason. It could also enable them to compare prices across retailers and manage their shopping lists among other things.

The Social Platform

The social platform of the VIVIA™ application allows customers to share deals, coupons and promotions. It enables customers to post reviews and comments and also read the same about stores and products they are interested in shopping for. The platform can also be used by retailers and manufacturers to promote new products and advertise products and deals thus attracting customers and driving sales. Customers and request suggestions from others within or outside their social circles. The social platform integrates and leverages existing social networks as well to enhance the usability and effectives.

Application Features

The app can be downloaded over the data connection and installed in the Smart Device.

In some examples, the app has the capability to detect the store location if the retailer is a part of chain with multiple stores by virtue of linking to the GPS functionality of the Smart Device and using mapping services like Google Maps or TeleNav GPS navigator. This enables each location to have unique prices and promotions. Based on the past shopping history (e.g., frequent customer) the app can prompt discounts on products while the customer shops. Customers have the option of turning on/off this feature during each shopping visit. They may prefer to turn it off in case they are only concerned with the shopping time and not the best available prices. Also if a customer were to select a competitors' product the app could generate a discount within pre-set limits to maintain customer loyalty for the frequently shopped for product. Such discounts may be set by the retail store administrators or based on potential manufacturer discounts.

In some examples, when launched the app typically asks for a login and password unless a user is always logged in. The Store Rewards (Loyalty) Card information typically also is stored in the user account. The user also has the option to have his credit card information or other payment login information e.g. Paypal stored in his account to make the payment process effortless. The app then shows the start screen (see, e.g., FIG. 3). In the example shown in FIG. 3, the start screen has 5 buttons as follows:
To access the Shopping List,
To Scan an Item
To Delete an Item
Show items in the basket and
To Pay

Please note that more or fewer buttons could be added depending on the available feature set.

A customer may use his app “while at home” by logging in and selecting the store location. Thus a shopping list could be created from home. In some examples, retail stores provide the option to pre-pay for the items from home and have them packed up and ready for pick-up within a certain pre-selected time window. The items available for shopping from home may be a sub-set of the items that would be available on the store shelves for self-shopping while in the store.

Referring to FIG. 4, the “shopping list” typically includes a list of items that were generated using any of the following or a combination of the options:
Manually entered as a generic type of product or a product of a particular brand or using a search function have an option to select the exact brand of a particular item type,
A list of frequently shopped for items as stored in the shopping list database. The shopping list database would populate the current shopping list with the most recently purchased brand and size of product. However the customer would have the option to select a different brand, size or feature if they are available by selecting an option to be prompted for such options. In some examples, this feature is enabled by categorizing the products as they are entered into the store database (e.g., based on metadata associated with the products, either directly or through a database lookup). Additionally the Store Admin could add features or additional cross-linking information to identify similar items in the VIVIA™ Server through the Admin panel. Alternatively the VIVIA™ Server could run searches on the internet automatically or using manually assigned rules to identify products in the database with similar features or;
A list created by manually scanning items at home that have run out or are close to running out and needed to be replenished.
Created by speaking to the phone using the voice recognition capability of the app. The customer could speak just the type of products and query the database to select the exact product or mention a Brand and type to add a more specific product. In some examples, the mapping between generic product type and specific products is determined based on cross-linking product information stored in the VIVIA™ Server Inventory Database.

Based on the items in the shopping list, store location, and layout of the store the app calculates an “estimated shopping time”. In some examples, the estimated time is calculated by taking the following parameters into consideration:
Average time to scan an item—s.
Average time to place items in the cart—p.
The distance between two consecutively located items in the store.
Average time needed to walk from point to point in the store. Since the store layout is stored in the database the lengths of all the aisles and distances from any point to any point can be calculated—w1, w2, w3, w4 and w5 (e.g. for 5 items).
Time to walk to demagnetizing station—wd
Time to walk to printer—wp
Time to walk to checker at exit—wc
Average time to pay using the online methods. For a particular customer his own preferred method of payment is used in the calculations—t.
Average time to demagnetize items if any—d1 (e.g. Item 1 needs to be demagnetized)
Average time to print the receipt—p.
Average time for checker to check the receipt and tally the items—c.

In these examples, the estimated shopping time (ST) is given by:

ST=5*(s+p)+w1+w2+w3+w4+w5+wd+wp+wc+t+d1+p+c

Upon clicking on the shopping list the app displays the list of items on the shopping list. The list could also display the price of the item and the aisle where it is located. The item from the shopping list is looked up in the store layout database to figure out where in the store it is located. The item location can then be presented to the customer in any of the following ways:
The location is displayed in a format that looks somewhat like e.g. B23 where B is the aisle, 2 is the section in the aisle and 3 is the shelf.
Or a map of the store can displayed and the path through the aisles leading to the product is highlighted
Alternatively step-by-step directions can be given leading to the location of the product. The directions can be voice guided and/or arrows on the screen.

This feature can be enabled by the GPS built-into the Smart Device or by installing sensors in the store that communicate with the Smart Device using Wi-Fi or Bluetooth to identify the location of the customer within the store in relation to the location of the product.

In some examples, the app also has the ability to suggest alternate items that are located closer to each other to optimize the shopping time for customers who are really pressed for time and want to get in and out of the store as quickly as possible. In some examples, the alternative items suggestions are determined by doing searches against the features and cross-linking information stored in the VIVIA™ Server Inventory Database. The retail store could have one aisle where they have a limited number of choices of all frequently shopped for items. The items could have a price mark-up for convenience. Customers who are pressed for time would be directed to such an aisle for quick shopping.

In some examples, the app receives advertising for similar “products that are cheaper”. In some of these examples, the app transmits the items in the shopping list to the VIVIA™ servers, which in turn generate queries on the Store Inventory Database and the Discounts & Offers database for the item in the shopping list to find closest matches in terms of the functionality of each item, size of the item and alternatives selected by other customers. The matches are determined by doing searches on the Store Inventory Database using the features and cross-linking information. Accordingly the app recommends alternate products.

Customers also may use the app to query the database to request alternate products that would minimize the total shopping cost for a particular shopping list. This may be done for the entire shopping list or a partial shopping list by marking items that should or should not be replaced with cheaper items. In this process, the app may transmit one or more requests that cause the VIVIA™ servers to query the Store Inventory Database and the Discounts & Offers database to find the combination of similar items that would minimize the shopping bill. The customer would have the option to accept or reject a suggestion or redo a search as appropriate.

The customer may replace an item on the shopping list with a similar item from another manufacturer if it were cheaper or had more desirable features.

In some examples, when the customer finds an item he or she likes, the customer scans the item (e.g., using the camera of the Smart Device) and places the item in the cart. The scanning function in the app turns on the camera in the Smart Device and then the customer scans the barcode of the item to be purchased. The Smart Device communicates with a VIVIA™ server connected to the back-end store database. When the customer logs into his app he gains a secure connection to the VIVIA™ server through a web-based app. The VIVIA™ server has an admin application that allows the store admin to manage the database and do a periodic sync-up with the store database to update product list, prices and product location. The barcode information from the scanned item is transmitted to the VIVIA™ server to find a match for the item and accordingly the price of the item, location of the item along with any discounts the customer would qualify for based on his Rewards Program are retrieved. This action then removes the item from the shopping list and places it in the shopping basket. This continues till the customer finishes shopping. If the customer changes his/her mind and does not wish to purchase an item that was already scanned the customer clicks on the delete button and is then given the option to remove items from the shopping basket.

Items that need to be weighed can be weighed on an “Electronic Weighing scale with barcode printer” which is an existing product. The barcode can then be scanned and the item added to the shopping cart.

Once the shopping list is exhausted the customer may shop for any additional items or review the shopping basket and go to the payment options.

C. Completing the Transaction & Payment Options

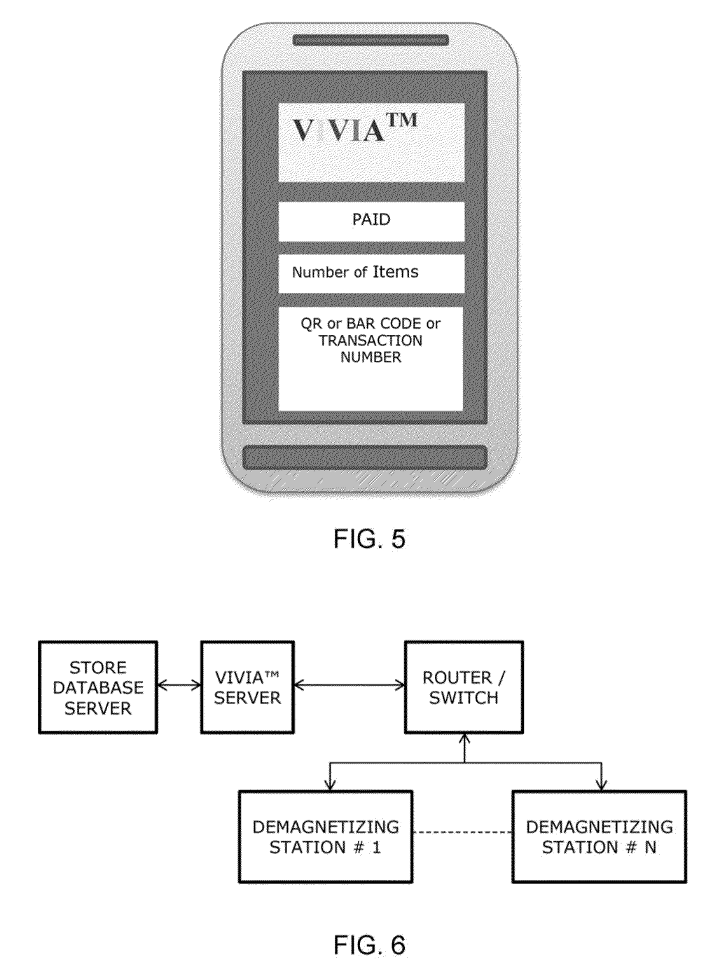

Referring to FIG. 5, the customer may to choose any online payment method he prefers. Some examples include Google Wallet, PayPal, VISA, MASTERCARD, American Express, Mobibucks, Square, or similar. Accordingly, the customer selects the preferred option. The Smart Device communicates with the payment provider over the wireless connection (3G/4G/Wi-Fi or similar) and charges the customer for the total amount of the transaction and sends a confirmation to the app and this completes the purchase. The app then generates a receipt for the purchase along with a unique identifier for the transaction see FIG. 5. The receipt can be viewed on the screen of the Smart Device and lists all the items purchased along with the prices and quantities. The unique identifier could be a bar code or a QR code or a unique 16-digit code (or more or less) identifying the transaction. The code could contain alphanumeric characters as well. The code contains information that enables the back-end database to locate the details of the transaction in terms of the items purchased, number of each item and price of items. The code could also contain information to identify the location of the store, and date/time of purchase and time spent by the customer in the store (e.g., the time from scanning the first item to the time the customer completes the payment and prints the receipt or scans the code to exit the store). In some examples, this information is analyzed the VIVIA™ servers (e.g., to develop a mode of customer behavior).

When the payment has been successfully completed a message is transmitted to the VIVIA™ Server to decrement the items paid for from the Store Inventory Database.

D. Demagnetizing Stations

In some examples, a retail store has one or more demagnetizing stations located near the exit for demagnetizing the store items that have a magnetic security device installed. The customer could swipe those items that have been paid for over these demagnetizing stations to disable the security device. These demagnetizing stations communicate with the VIVIA™ Server to ensure that an item has been paid for before demagnetizing it.

FIG. 6 shows an example of a demagnetizing station network setup that includes a number of Demagnetizing stations installed in the store. These are connected to a Router/Switch type device which communicates with the VIVIA™ Server. The VIVIA™ server in turn communicates with the Store Database Server. The software running on the Router polls the Demagnetizing stations and, when a customer places the security device of an item near the station, the Demagnetizing station scans the security device with item information and routes it to the VIVIA™ Server. The VIVIA™ Server confirms whether the item has been paid for and if yes it informs the Store Database which in turn issues a token to allow the security device on the item to be demagnetized. The customer is then clear to proceed to the checker.

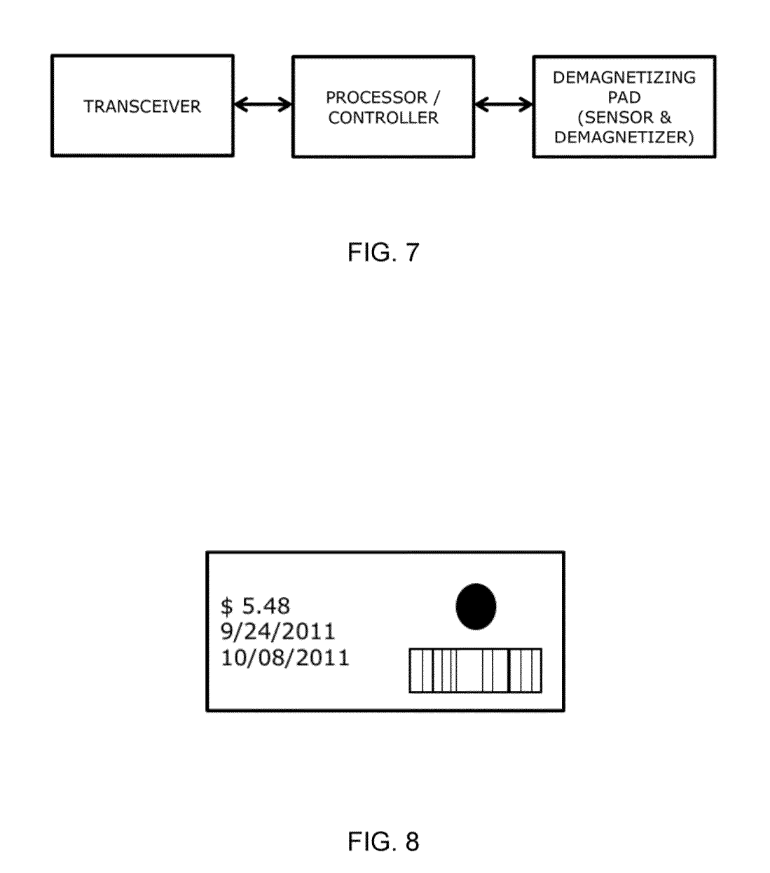

FIG. 7 shows a block diagram of an example of a demagnetizing station that includes a transceiver, a processor/controller, and a demagnetizer. Via the transceiver, the processor/controller is operable to communicate with the VIVIA™ Server. The demagnetizer typically includes a pad on which items to be demagnetized are placed, a sensor for detecting an item placed on the pad, and a demagnetization unit that is operable to generate a field (e.g., a magnetic or electromagnetic field) that deactivates the security device on the item placed on the pad.

E. The Checkout

In some examples, the customer can exit the store in one of the following ways:
NFC Method #1: The customer places his NFC enabled Smart Device near a NFC reader and the NFC reader is connected to a printer to print a receipt which the customer then shows to a checker at the gate who compares the items on the receipt with those in the cart and permits the customer to exit.
NFC Method #2: The customer places his NFC enabled Smart Device near a NFC reader and the NFC reader is connected to a display to show the receipt which the checker at the gate views and compares to items in the cart and allows the customer to exit.
Bar/QR Code Method #1: The customer places the Bar/QR code generated on his Smart Device near a Bar/QR code reader and the reader is connected to a printer to print a receipt which the customer then shows to a checker at the gate who compares the items on the receipt with those in the cart and permits the customer to exit.
Bar/QR Code Method #2: The customer places the Bar/QR code generated on his Smart Device near a Bar/QR code reader and the reader is connected to a display to show the receipt which the checker at the gate views and compares to items in the cart and allows the customer to exit.
Transaction Code Method #1: The customer enters the transaction code in numeric keypad connected to a receipt printer and prints a receipt which the customer then shows to a checker at the gate who compares the items on the receipt with those in the cart and permits the customer to exit.
Transaction Code Method #2: The customer enters the transaction code in numeric keypad connected to a display to show the receipt which the checker at the gate views and compares to items in the cart and allows the customer to exit.

A mechanism ensures that once the code is a one-time use only code and thus once it is used to exit the store using any of the above methods the code is disabled and cannot be reused. This would prevent misuse.

### 4. An Alternate Item Coding System

The products in a retail store can be labeled with the VIVIA™ coding system that contains additional information. This is as compared to sticking a price tag to the item

FIG. 8 shows a VIVIA™ coded label that can be affixed to products in the store in the same way price tags are attached to products. The label includes a magnetic region, a machine readable region (VIVIV™ coding) that encodes information relating to a product including product identifying information, and a human readable region that includes visible human readable characters relating to the product including purchase price information.

In some examples, the machine readable region is a bar code that encodes information including but not limited to the following information:
Price of the Product
Date of Manufacture
Date of Expiry

The magnetic dot enables automatic counting. For example, a bag full of 5 items each with a VIVIA™ label will count as 5 items and should match the number of items on the receipt as a person exits the store.

In one embodiment, the magnetic dot is carried on a region of the Label and typically includes ferromagnetic material that can be sensed by magnetic sensors placed at the exit. The actual scanning to get the item count could be done by any of the following methods:
customers could place their shopping bags on a belt that carries the shopping bags past magnetic counters or
the shopping bags could be carried through magnetic counter panels or
the shopping bags could be placed on a magnetic counter pad momentarily so they can be scanned and the items counted

In some examples, a retail store is equipped with a counting station that includes magnetic sensors that are arranged on both sides, top and bottom of a belt that carries the shopping bags. In this way, the bags can be thoroughly scanned and the items in the bag counted accurately. The actual size and shape of the ferro-magnetic dots may be empirically determined and typically depend on the speed of the conveyer belt that carries the bags.

### 5. Exemplary Features of the VIVIA™ Solution

1. A Smart Device Application software:
   a. Runs on iPhone, iPad, Tablet, Android, Windows, etc. operating system
   b. Can be used to scan items in a store
   c. Can be used to pay for the items using
      i. Google Wallet
      ii. Credit/Debit Cards already stored
      iii. Paypal
      iv. Direct debit from checking/savings account
      v. Mobibucks
      vi. Square
   d. Also acts a Rewards cards
      i. To give customers additional discount
      ii. To allow customers to collect points that can be redeemed later
      iii. To understand customer preferences and accordingly suggest items as they shop
   e. Generates a receipt at the end of the purchase
   f. Generates an unique QR code at the end of the purchase
2. The software can also be used to order items remotely and transmit the order to the store such that the store can keep the items ready for pick within a certain time window.
3. The app can also be controlled by normal voice commands.
4. The QR code generated at the end of the purchase is unique and as the customer exits the store it is scanned and then disabled so that it cannot be used once again to exit the store.
5. The software also remembers
   a. The items that a customer shops for most frequently
   b. Allows the customer to create shopping lists by
      i. Typing in the item names
      ii. Just scanning an item at home when the see it is almost finished. Thus automatically creating a shopping list.
      iii. Voice Search
6. The software can be customized and branded for a Store (OEM) such that:
   a. It has all the SKUs for the store by virtue of being connected to the back-end database. The VIVIA™ Server gets updated periodically by connecting to the store database.
   b. It has all the Aisle numbers for the items. Thus when a customer wants to purchase a product in the store his shopping list also has the Aisle number beside it. This enables him to directly walk up to that aisle and pick-up the item. Thus saving time.
7. Since the app software is hooked in to the back-end of the store as a customer picks up an item and scans it to purchase it and then pays of the item, it get removed from the inventory. Items can be deleted manually after being scanned if a customer decides not to purchase it. In that case the item is not removed from the inventory.
8. The software also has a web-portal that is linked and shows all the same information as can been seen in the Smart Device app like:
   a. Shopping lists
   b. All receipts of purchases so they can be printed at home if required
   c. Allows the customer to sort by item name or category to see how much spent on a particular item during the year e.g. how much was spent on printer paper by a small business.
   d. Can also show price comps at other competitor stores so customer can be assured that he is getting the best price.
9. Potential customers could be any of the following but not limited to these: Each of the retailer or store may need unique customization based on the types of products they carry, the customer behavior and preferences and type of shopping experience they would like their customers to have.
   a. Large grocery chains
   b. Large electronic retailers
   c. Designer clothing stores
   d. Departmental stores
   e. Public Transportation: e.g., Scan a QR code at the entrance then pay with your Smart Device and the QR code generated on your phone could be scanned to open a gate to let you into the platform to catch a train.
   f. Amusement Parks: e.g. Scan a QR code at the entrance then pay with your Smart Device and the QR code generated on your phone could be scanned to open a gate to let you into the park.
   g. Restaurants and eating places.
10. For stores that carry expensive products and have an electronic security device. Once the item is scanned and then paid for it is registered as paid in the store database. Subsequently the customer would walk up to a deactivation station and flash his item over it to deactivate the security device and could then proceed to the exit.
11. Revenue Model:
   a. Customized for a Retail Store/Business for free and the loyal store customers can download the App for free when they sign-up for the Store Rewards Program.
   Consumer Product companies would pay for advertising into the App. A manufacturer purchases an ad from an advertising firm and the firm send the app to the VIVIA™ server along with the details of the type of customers to be targeted which could include information stored when they created a profile to download the app or when they signed up for the rewards program or based on the types of items they frequently shop for. The VIVIA™ server then matches these criteria based on certain use models to target ads to customers such that:
      i. When a customer scans a product, the competitors can pitch their product along with the differentiating value. This pops up on the screen with the price and feature benefit and the customer has the choice to accept or reject it. In one embodiment the ads could be stored in the VIVIA™ servers. The Customers who select time of shopping as their priority when they begin their shopping will not be prompted.
      ii. When a customer opens up his shopping list the VIVIA™ Server locates Ads for similar products and flashes their Features and location
      iii. When a customer queries the location of a product the App suggests the alternates based on the subscribed Ads.
   b. VIVIA™ customizes for free for the Retail Store/Business and then:
      i. A small incremental amount each time a store customer downloads the app “or”
      ii. Each time a store customer makes a purchase using the App VIVIA™ gets a % of the total amount purchased.
   c. The Retail Store/Business pays VIVIA™ a one-time fee for customizing and installing the product good for “X” number of downloads. After the “X” is exhausted they would pay VIVIA™ another fee for purchasing the rights to allow “Y” number of downloads and so on.
12. Appliance that talks to database in the backend.
13. After scanning an item if a customer changes his mind he can delete the item from the list before paying.
14. A checker at the entrance would match the number of items purchased against one or more of the following:
   a. A receipt that is printed at a printer station after the payment is complete
   b. A receipt generated on the phone
   c. A QR code generated that can have the number of items listed and when scanned during exit would flash the receipt and total number of items on a screen making it easy for the person at checkout to match the numbers and verify.
   Alternatively the shopping bags could be passed through a magnetic counter that counts the number of items and matches that number against the number of items paid for, as indicated by any of the above methods.
15. Items that need to be weighed could be placed on a weighing scale after being bagged and the scale would print out a bar code that is scanned by the phone and then the bar code is affixed to the bag.
16. Items to be returned after exiting the store would have to be done by customer service personnel.
16. Shopping list features
   a. Enter items into shopping list
      i. Manual entry
         1. Typed entry
         2. Speech entry
      ii. Based on historical purchases
         1. List of most frequently purchased
      iii. Scan product ids of products needed
   b. Based on current shopping list report product finder information
      i. Which stores carry products
         1. Which is the store that carries most of products
      ii. Where products are located in particular store
   c. Remove items from shopping list
      i. Manually
      ii. Scan bar codes of items selected for purchase
   d. Analysis of user's current shopping list
      i. Tailor ads based on results of analysis
         1. Determine user profiles categories that are mapped to product advertisement categories
      ii. Product promotions
         1. Discounts and other offers that are available for items
   e. Maintain personal historical shopping database
      i. User's shopping lists
         1. Each data record includes
            a. User id
            b. Entry date & time
            c. Product category
            d. Product id
      ii. User's actual purchases
         1. Each data record includes
            a. User id
            b. Purchase date & time
            c. Product id
            d. Product price
            e. Retailer id
      iii. Manage Rewards Program
   f. Analyze user's personal historical shopping database
      i. Analysis of user's shopping list
         1. Product location in the selected store location
         2. Product price once store location is selected
         3. Estimated shopping time based on Shopping list and location selected
      ii. Analysis of user's actual purchases
         1. Purchase quantities and locations for inventory management
         2. Historical purchase behavior for determining best price monitoring for user (e.g., by favorite products)
         3. Provide information to user for purchase management
            a. End of month purchase summary
            i. Products
            ii. Total costs
      ii. Combined analysis of user's shopping lists and actual purchases
         1. Use previous shopping habits and current shopping list to infer future demand from this customer (by location)
            a. Inventory management
            b. Product promotion management
17. Using mobile device, scan item and provide shopping information
   a. Where to buy
   b. Best price
   c. Applicable discounts and other promotions
   d. Alternative products recommendations
18. Demagnetizing station with integrated purchase confirmation functionality
19. Product label enabling blind counting of purchased products

### 6. Conclusion

Other embodiments are within the scope of the claims.

1. A method, comprising:
receiving from a remote network node product identifying information associated with a user identifier;
determining respective product identifiers based on the received product identifying information;
maintaining in association with the user identifier a personal shopping database of shopping records respectively comprising the determined product identifiers;
ascertaining information relating to one or more of the shopping records in the personal shopping database; and
transmitting the ascertained information to the remote network device.

2. The method of claim 1, wherein the maintaining comprises designating respective ones of the shopping records as being associated with a current shopping list, and designating other respective ones of the shopping records as purchased product shopping records.

3. The method of claim 2, wherein the ascertaining comprises ascertaining the product identifiers that are associated with the current shopping list.

4. The method of claim 3, wherein the transmitting comprises transmitting a description of the current shopping list to the remote network node.

5. The method of claim 3, further comprising, based on an indication that a product corresponding to a particular product identifier has been purchased, disassociating a particular one of the shopping records from the current shopping list and designating the particular shopping record as a purchased product shopping record.

6. The method of claim 3, further comprising, based on an indication that particular product identifying information corresponds to a product that has not been purchased, creating a particular shopping record comprising the respective product identifier determined from the particular produce identifying information, and designating the particular shopping record as being associated with the current shopping list.

7. The method of claim 3, wherein:
the ascertaining comprises, based on the current shopping list, determining product location information comprising one or more locations where one or more products corresponding to respective ones of the product identifiers associated with the current shopping list are located; and
the transmitting comprises transmitting the product location information to the remote network device.

8. The method of claim 7, wherein the determining of the product location information comprises determining one or more retail stores carrying one or more products associated with the current shopping list, and the transmitting comprises transmitting information relating to the one or more determined retails stores to the remote network node.

9. The method of claim 8, wherein the determining of the product location information comprises identifying a respective one of the retail stores nearest to the remote network node, and the transmitting comprises transmitting information relating to the identified retail store to the remote network node.

10. The method of claim 8, wherein the determining of the product location information comprises identifying a set of one or more of the retail stores collectively carrying all the products in the shopping list at a lowest total purchase price, and the transmitting comprises transmitting information relating to the one or more identified retail stores to the remote network node.

11. The method of claim 8, wherein the determining comprises identifying a respective one of the retail stores carrying a highest number of the products in the shopping list at a lowest total purchase price, and the transmitting comprises transmitting information relating to the identified retail store to the remote network node.

12. The method of claim 7, wherein the determining of the product location information comprises determining a particular location in a particular retail store carrying a product associated with the current shopping list, and the transmitting comprises transmitting information relating to the particular location in the particular retail store.

13. The method of claim 12, wherein the particular location comprises an aisle number and shelf number.

14. The method of claim 7, wherein the determining of the product location information comprises communicating with one or more retail stores administered product inventory databases.

15. The method of claim 7, further comprising receiving location information describing a current location of the remote network device, and the determining of the product location information is based on the received location information.

16. The method of claim 7, further comprising receiving from the remote network device a request to purchase a list of products from a particular retail store, and transmitting the request to the particular retail store.

17. The method of claim 16, wherein the request comprises an indication that the request is for pick-up at a drive-through location associated with the particular retail store.

18. The method of claim 2, wherein the ascertaining comprises deriving a current shopping list from respective ones of the shopping records designated as purchased product shopping records, and the transmitting comprises transmitting the derived current shopping list to the remote network node.

19. The method of claim 2, wherein the maintaining comprises, for each of the shopping records associated with the current shopping list, recording the user identifier, a date and time indicating when the record is added to the current shopping list, and the respective product identifier.

20. The method of claim 2, wherein the maintaining comprises, for each of the shopping records designated as purchased product shopping records, recording the user identifier, a purchase date and time, the respective product identifier, a purchase price, and a purchase location identifier.

21. The method of claim 1, wherein the ascertaining comprises ascertaining information relating to a rewards program associated with the user identifier, and the transmitting comprises transmitting the information relating to the rewards program to the remote network node.

22. The method of claim 1, further comprising analyzing respective ones of the shopping records in the personal shopping database, and based on results of the analyzing determining strategic management information

23. The method of claim 22, wherein the strategic management information comprises purchase quantity information and purchase location information, and further comprising transmitting the purchase quantity and purchase location information to one or more entities managing one or more respective retail stores associated with the purchase location information.

24. The method of claim 23, wherein the analyzing comprises determining the purchase quantity information based at least in part on respective ones of the shopping records associated with a current shopping list.

25. The method of claim 22, wherein the analyzing comprises identifying one or more target products purchased in association with the user identifier, the strategic management information comprises determining lowest price information for the one or more target products, and the transmitting comprises transmitting the lowest price information for the target products to the remote network node.

26. The method of claim 22, wherein the analyzing comprises determining one or more summaries of purchase patterns associated with the user identifier, and the transmitting comprises transmitting the one or more purchase pattern summaries to the remote network node.

27. A handheld device, comprising:
an input component;
an output component;
a transceiver operable to communicate wirelessly with nodes on a network;
a processor operable to perform operations comprising
generating a graphical user interface comprising a shopping list, controls for managing the shopping list, and controls for entering product identifying information through the input component,
via the transceiver, transmitting to the server network node requests associated with queries on the personal shopping database,
in connection with the requests, receiving product information from the server, and
updating the graphical user interface based on the received product information.

28. The handheld device of claim 27, comprising a microphone, and wherein the processor is operable to perform speech recognition operations comprising converting speech signals received from the microphone into commands for managing the shopping list and determining product location information comprising one or more locations where one or more products corresponding to respective ones of the product identifiers associated with the current shopping list are located.

29. A demagnetizing station, comprising:
a demagnetizer;
a scanner operable to produce a scan signal from a scan of an article;
a transceiver;
a processor operable to perform operations comprising
determining product identifying information from the scan signal,
via the transceiver transmitting the product identifying information to a server network node,
via the transceiver receiving purchase information from the server network node,
based on the received purchase information determining whether or not demagnetization of the article is authorized, and
via the demagnetizer demagnetizing the article based on a determination that demagnetization of the article is authorized.

30. A label, comprising:
a substrate carrying
a magnetic region
a machine readable region that encodes information relating to a product including product identifying information;
a human readable region comprising visible human readable characters relating to the product including purchase price information.
